(19) United States
(12) Patent Application Publication
(10) Pub. No.: US 2026/0286951 A1
(43) Pub. Date: Sep. 24, 2026

(54) Hydrostatic Rotary Machine Having Counting Apertures on a Second Brake Disc

(71) Applicant: Robert Bosch GmbH, Stuttgart (DE)

(72) Inventors: Adam MacPhee, Kircaldy (GB); Carlos Tellez, Peth (GB); Evangelos Rompogiannakis, Glasgow (GB); Frank O'Hara, Auchtermuchty (GB); Johann Praeffcke, Scotlandwell (GB); Laurent Eugene Albert, Frignicourt (FR)

(21) Appl. No.: 19/571,249

(22) Filed: Mar. 18, 2026

(30) Foreign Application Priority Data
Mar. 20, 2025 (DE) 10 2025 110 811.0
Mar. 26, 2025 (DE) 10 2025 111 681.4

(51) Int. Cl. F04B 49/06; F04B 1/2092

(52) U.S. Cl. CPC F04B 49/06; F04B 1/2092; F04B 2201/0805

(57) ABSTRACT

A hydrostatic rotary machine has coaxial inner and outer elements, one of which is a rotor and the other of which is a stator. A brake includes a plurality of first brake discs and a plurality of second brake discs arranged alternately along the axis of rotation. The first brake discs are connected rotationally fixed relative to the axis of rotation with the outer element, and the second brake discs are connected rotationally fixed relative to the axis of rotation with the inner element. A plurality of counting apertures, formed by at least one second brake disc, are arranged on the inner element distributed around the axis of rotation. A sensor is received in the outer element and is arranged opposite the counting apertures such that a rotation of the rotor results in a signal change at the sensor.

This application claims priority under 35 U.S.C. § 119 to application no. DE 10 2025 110 811.0, filed on Mar. 20, 2025 in Germany, and to application no. DE 10 2025 111 681.4, filed on Mar. 26, 2025 in Germany, the disclosures of which are incorporated herein by reference in their entirety.

The disclosure relates to a hydrostatic rotary machine.

### BACKGROUND

A hydrostatic rotary machine is known from the data sheet “Radial piston motor for integrated drives MCR-H” (order number RE 15199, edition March 2017) of Bosch Rexroth AG, which is formed as a radial piston motor. In a radial piston motor the outer element forms the stator, wherein the inner element forms the rotor. However, the opposite configuration is likewise conceivable. The rotor is mounted by rotary bearings rotatably relative to the axis of rotation on the stator. The rotor comprises a plurality of cylinders, in each of which a piston is received so as to be linearly movable radially to the axis of rotation. A wave-shaped cam track is arranged around the rotor. During operation of the hydrostatic rotary machine, rotatable rollers of the pistons contact the cam track such that a rotary movement of the rotor is accompanied by a stroke movement of the pistons. The hydrostatic rotary machine may be equipped with a brake which is formed as a multi-disc brake. Furthermore, a sensor may additionally be provided with which the rotational speed of the rotor is measurable. For this purpose the sensor scans counting apertures which are arranged on the end face of the rotor. The counting apertures are formed by a separate sheet-metal plate which is fastened to the end face of the rotor.

A further hydrostatic rotary machine is known from EP 3 233 553 B1, which is distinguished by a particularly compact design. This is achieved, inter alia, in that the rotary bearings have approximately the same diameter as the cam ring which forms the cam track. This configuration of the rotary bearings makes it impossible to use the counting apertures according to the data sheet described above.

### SUMMARY

One advantage of the present disclosure consists in that the counting apertures are provided in a particularly cost-effective manner. Moreover, the disclosure is also usable in a particularly compact hydrostatic rotary machine, which is formed according to EP 3 233 553 B1.

According to the disclosure, it is proposed that the counting apertures are formed by at least one second brake disc. As a result, the sheet-metal plate with the counting apertures described with reference to the above aforementioned data sheet may be omitted. Preferably, the sensor comprises a Hall element with which a magnetic field modulated by the counting apertures is measured. The magnetic field may be caused by at least one permanent magnet and/or by at least one electromagnet. Preferably, the first brake discs are of identical configuration to one another. Preferably, the second brake discs are of identical configuration to one another. Preferably, a plurality of second brake discs are provided with counting apertures, wherein, most preferably, all of the second brake discs are provided with counting apertures.

It may be provided that the counting apertures are formed in one piece by the respective second brake disc. The second brake discs may be produced by means of a stamping process or by means of a laser-cutting process. Within the scope of these manufacturing methods, the proposed counting apertures may be produced with virtually no additional effort.

It may be provided that the counting apertures are arranged on an outer circumferential surface of the respective brake discs. Therefore, a sensor mounted on the outer element may scan the counting apertures without difficulty.

A plurality of second brake discs having counting apertures may be provided, wherein the counting apertures of the different second brake discs are arranged in alignment when viewed in the direction of the axis of rotation. The sensor, in particular its Hall element, with which the counting apertures are scanned, subsequently delivers a signal that has a high signal-to-noise ratio, such that it is easy to evaluate.

It may be provided that at least the counting apertures which are located in the region of the sensor project radially outward relative to the axis of rotation over at least a portion of the first brake discs. It is preferred that both the first and the second brake discs consist of steel, such that both types of brake discs are ferromagnetic. The aforementioned projection ensures that the signal of the sensor, in particular, the signal of the corresponding Hall element, has a high signal-to-noise ratio. In particular, the signal-to-noise ratio is higher than in the case of counting apertures which are arranged recessed between ferromagnetic first brake discs while they are being scanned by the sensor. Preferably, the counting apertures located in the region of the sensor project radially outward relative to the axis of rotation over all first brake discs.

It may be provided that at least a portion of the first brake discs has a recess in the region of the sensor, such that the counting apertures located in the region of the recess project radially outward relative to the axis of rotation over at least a portion of the first brake discs. In this way, the preferred radial projection of the counting apertures may be achieved without the installation space requirement of the first brake discs increasing. It should be noted here that the outer diameter of the first brake discs determines the installation space requirement for the entire hydrostatic rotary machine. Preferably, all first brake discs have a corresponding recess in the region of the sensor.

It may be provided that an outer diameter of the counting apertures is smaller than an outer diameter of the first brake discs, such that the counting apertures are arranged recessed between the first brake discs outside the aforementioned recess. In that case, the region of the second brake discs that is provided with the counting apertures also contributes to the braking effect of the brake.

It may be provided that the first brake discs are each formed as a flat plate having a constant thickness, wherein the recess is formed by an outer contour of the respective first brake disc. Preferably, the first brake discs are produced from sheet metal, wherein the aforementioned outer contour is stamped or cut out with a laser beam. Such first brake discs are particularly cost effective.

It may be provided that the outer contour of the first brake disc, away from the recess, has a plurality of circular sections relative to the axis of rotation, wherein, in the circumferential direction, projections that project radially outward relative to the rotational axis are arranged between the circular sections, wherein the projections engage in a form-fitting manner in the outer element. In this manner, a connection that is rotationally fixed relative to the axis of rotation is provided between the first brake discs and the outer element. Preferably, the above-mentioned outer diameter of the first brake discs is defined by the circular sections.

It may be provided that the rotor is mounted rotatably relative to the axis of rotation on the stator by means of a first and a second rotary bearing, wherein the pistons are arranged in the direction of the axis of rotation between the first and the second rotary bearing, wherein the first and the second rotary bearing are each formed as rolling bearings, wherein the corresponding rolling bodies run on a diameter that is between 90% and 110% of an average diameter of the cam track. Additionally or alternatively, it may be provided that the rotor is mounted rotatably relative to the axis of rotation on the stator by means of a first and a second rotary bearing, wherein the pistons are arranged in the direction of the axis of rotation between the first and the second rotary bearing, wherein the cam track is arranged on a separate cam ring, wherein the cam ring and the first and the second rotary bearing are each formed to be of such a size in terms of their diameter that, when viewed in the direction of the axis of rotation, they overlap in pairs. Such mounting of the rotor makes it possible to achieve a particularly compact hydrostatic rotary machine. However, this mounting has the consequence that the sensor according to the data sheet explained at the outset and the associated counting apertures are no longer usable, wherein the sensor according to the disclosure and the associated counting apertures remain usable without difficulty.

It may be provided that the second brake discs are each formed as a flat plate having a constant thickness, wherein the counting apertures are formed by an outer contour of the respective second brake disc. Preferably, the second brake discs are produced from sheet metal, wherein the aforementioned outer contour is stamped or cut out by means of a laser beam. Such second brake discs are particularly cost effective.

It may be provided that the counting apertures are each formed as teeth that are identical to one another, which are arranged uniformly distributed over the circumference of the second brake disc. Such counting apertures result in a particularly high signal-to-noise ratio of the signal of the sensor, in particular, the signal of the corresponding Hall element. The aforementioned teeth are preferably formed by the outer contour of the second brake disc.

It may be provided that a central axis of the sensor is oriented radially relative to the axis of rotation, wherein the sensor is arranged radially outside the first and the second brake discs. This arrangement of the sensor results in a particularly high signal-to-noise ratio of the signal of the sensor, in particular of the signal of the corresponding Hall element. Preferably, the central axis of the sensor coincides with a cylinder axis of a circular-cylindrical receiving bore in the outer element into which the sensor is installed.

It is understood that the features mentioned above and those still to be explained below are usable not only in the respective combinations indicated, but also in other combinations or individually, without departing from the scope of the present disclosure.

### BRIEF DESCRIPTION OF THE DRAWINGS

The disclosure on is explained in more detail below with reference to the accompanying drawings. The drawings show:

FIG. 1 a longitudinal section of a hydraulic rotary machine according to the disclosure;

FIG. 2 a perspective view of the hydraulic rotary machine according to FIG. 1, wherein the outer element is removed;

FIG. 3 a front view of a first brake disc; and

FIG. 4 a front view of a second brake disc.

### DETAILED DESCRIPTION

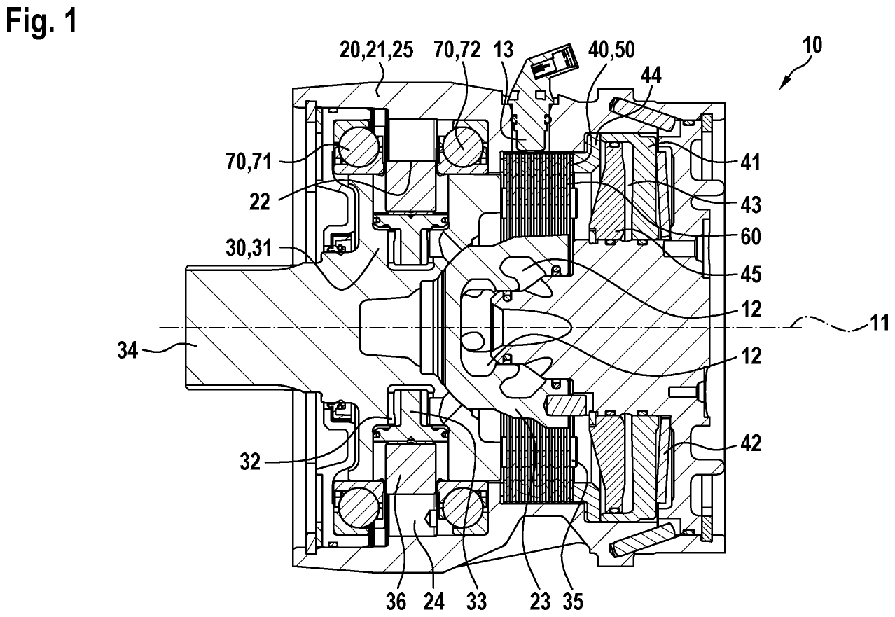

FIG. 1 shows a longitudinal section of the hydrostatic rotary machine 10. The corresponding sectional plane contains the axis of rotation 11, wherein it passes through the sensor 13. The hydrostatic rotary machine 10 is in the present case formed as a radial piston motor. Accordingly, the outer element 20 forms the stator 21, wherein the inner element 30 forms the rotor 31. The rotor 31 is mounted rotatably relative to the axis of rotation 11 on the stator 21 by means of a first rotary bearing 71 and a second rotary bearing 72, wherein the rotor 31 projects from the stator 21 by way of the drive pin 34. In the present case, the first rotary bearing 71 and the second rotary bearing 72 are formed as rolling bodies 70, in particular, as angular-contact ball bearings. The corresponding rolling bodies 70 are in the present case balls.

The rotor 31 has a plurality of cylinders 32, in each of which a piston 33 is received and is linearly movable radially relative to the axis of rotation 11, such that the piston 33 together with the rotor 31 in each case delimits a volume that changes when the piston 33 moves. The pistons 33 are arranged in the direction of the axis of rotation 11 between the first rotary bearing 71 and the second rotary bearing 72. A wave-shaped cam track 22 is arranged around the pistons 33 and around the axis of rotation 11, preferably which is formed by a separate cam ring 24. The pistons 33 each comprise a rotatable roller 36, which during operation of the hydrostatic rotary machine 10 bears against the cam track 22, such that a rotation of the rotor 31 is accompanied by a stroke movement of the pistons 33.

The stator 21 comprises a main body 25, which in the present case completely surrounds the cam ring 24. The stator 21 further comprises a fluid distributor 23, which is pressed by the pressure of the fluid in the direction of the axis of rotation 11 against the rotor 31, wherein it is received essentially stationarily on the main body 25. Preferably, the aforementioned fluid is a liquid, wherein hydraulic oil is most preferable. The fluid distributor 23 is formed such that the cylinders 32 are alternately connected with one of two working chambers 12, such that a rotation of the rotor 31 is accompanied by a fluid flow between the two working chambers 12. The two working chambers 12 are permanently connected to a respective associated working port (not visible in FIG. 1), which is arranged externally on the stator 21.

The hydrostatic rotary machine 10 is equipped with the brake 40, which is formed as a multi-disc brake. Accordingly, a plurality of first brake discs 50 and a plurality of second brake discs 60 are provided, which are arranged alternately along the axis of rotation 11. The first brake discs 50 are connected rotationally fixed relative to the axis of rotation 11 with the outer element 20, wherein the second brake discs 60 are connected rotationally fixed relative to the axis of rotation 11 with the inner element 30. Preferably, a first brake disc 50 lies directly against the rotor 31. Preferably, the pressure ring 44 lies against an opposite outer first brake disc 50, such that the entire stack of first and second brake discs 50, 60 may be pressed together by force application to the pressure ring 44, whereby the braking effect is generated.

The aforementioned force application is initially exerted by the preloaded spring 42, which in the present case is formed as a disc spring. The spring 42 presses the brake piston 41 against the pressure ring 44, such that the brake 40 is closed when the brake chamber 43 is unpressurized. The outer element 20 in the present case comprises the limiting ring 45, which together with the brake piston 41 that is movable in the direction of the axis of rotation 11 delimits the brake chamber 43. The limiting ring 45 is supported in the direction of the axis of rotation 11 on the outer element 20, preferably, on a retaining ring. The spring 42 and the brake chamber 43 are arranged on opposite sides of the brake piston 41 in the direction of the axis of rotation 11, such that pressurization of the brake chamber 43 reduces the force that is transmitted from the brake piston 41 to the pressure ring 44. By pressurization of the brake chamber 43, the brake 40 is accordingly released.

Reference is also made to the sensor 13, which is arranged in the radial direction relative to the axis of rotation 11 opposite the first brake discs 50 and the second brake discs 60. For example, the sensor 13 may be formed according to the data sheet “Speed Sensor DST” (order number RE 95131; issue of 18.03.2021) of Bosch Rexroth AG. This sensor 13 comprises at least one Hall element with which ferromagnetic counting apertures (no. 62 in FIG. 4) may be detected. With a single Hall element, only the rotational speed of the rotor 31 may be measured. With two or more Hall elements, the rotational direction of the rotor 31 may additionally be determined.

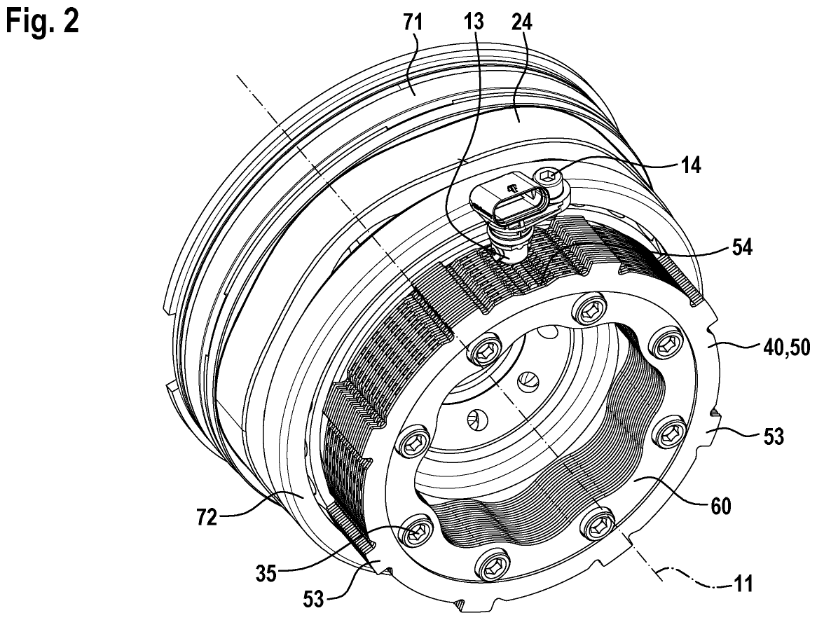

FIG. 2 shows a perspective view of the hydrostatic rotary machine 10 according to FIG. 1, wherein the outer element (no. 20 in FIG. 1) is removed. As can first be seen in FIG. 2, the first rotary bearing 71 and the second rotary bearing 72 are similar in size to the cam ring 24. This circumstance makes it impossible to arrange the sensor 13 and the counting apertures (no. 62 in FIG. 4) on the end face of the inner element (no. 30 in FIG. 1), as shown, for example, in the data sheet “Radial piston motor for integrated drives MCR-H” (order number RE 15199; edition March 2017) of Bosch Rexroth AG. According to the present disclosure, the counting apertures (no. 62 in FIG. 4) are instead formed by the second brake discs 60.

A central axis of the sensor 13 is oriented radially relative to the axis of rotation 11. The aforementioned central axis defines the region of maximum sensitivity of the sensor 13. The aforementioned central axis typically coincides with the cylinder axis of a circular-cylindrical receiving bore for the sensor 13. The sensor 13 is arranged radially outside the stack of first brake discs 50 and second brake discs 60, such that it faces the counting apertures (no. 62 in FIG. 4) on the second brake discs 60 at a small distance. Preferably, the sensor 13 is fastened with a fastening screw 14 to the outer element (no. 20 in FIG. 1).

In FIG. 2, the recesses 54 on the first brake discs 50 can be seen. There, the counting apertures (no. 62 in FIG. 4) of the second brake discs 60 project radially outward beyond the first brake discs 50, such that they are readily detectable by the sensor 13. The sensor 13 is accordingly arranged in the region of the aforementioned recesses 54. Away from the aforementioned recesses 54, the counting apertures (no. 62 in FIG. 4) are arranged recessed between the second brake discs 60.

The first brake discs 50 each have, in the present case, a total of eight radial projections 53 which engage in adapted grooves on the main body (no. 25 in FIG. 1). In this manner, the first brake discs 50 are connected rotationally fixed relative to the axis of rotation 11 with the outer element 20. The projections 53 of the first brake discs 50, which are formed identically to one another, are arranged in alignment in the direction of the axis of rotation 11.

The second brake discs 60 are connected rotationally fixed with the rotor 31 by means of a plurality of bolts 35. These bolts 35 are the subject of the German patent application with the reference number 102025106171.8, which was filed on Feb. 19, 2025. Here, eight bolts 35 are oriented parallel to the axis of rotation 11, wherein they are screwed into the inner element (no. 30 in FIG. 1). They each pass through a circular opening (no. 65 in FIG. 4) in the second brake discs 60.

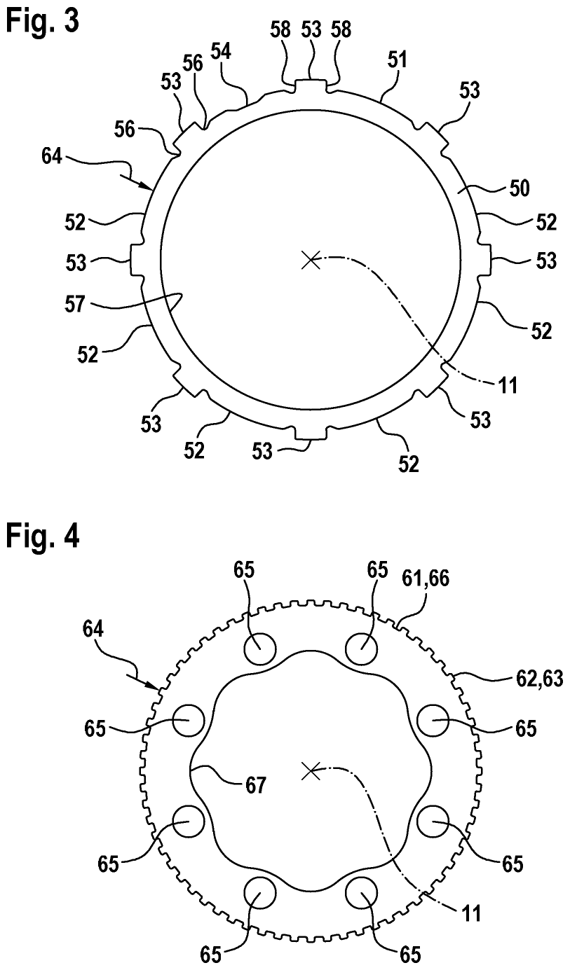

FIG. 3 shows a front view of a first brake disc 50. Preferably, all of the first brake discs 50 are formed identically to one another, such that they each have the outer contour 51 and the inner contour 57 shown in FIG. 3. They are each executed as a flat plate having a constant thickness. The first brake discs 50 preferably consist of steel, such that they are ferromagnetic.

The inner contour 57 of the first brake discs 50 is formed completely circular, wherein the corresponding circle center coincides with the axis of rotation 11. The outer contour 51 of the first brake disc 50 comprises a plurality of circular sections 52 that are arranged on a common circle whose circle center coincides with the axis of rotation 11. The recess 54 already explained above is recessed radially inward from this circle.

Furthermore, the outer contour 51 comprises a plurality of, in the present case eight, projections 53 that extend radially outward away from the first brake disc 50. These projections 53 are arranged uniformly distributed around the axis of rotation 11, wherein they are formed identically to one another. In particular, they have two parallel side surfaces 58 by means of which they bear against the opposite side walls of an adapted groove in the outer element (no. 20 in FIG. 1), in order to produce a rotationally fixed connection with the outer element. In the circumferential direction, a relief cut 56 is arranged on each of the opposite sides of each projection 53. The relief cut 56 is formed at a distance from the outer element (no. 20 in FIG. 1), such that only the side surfaces 58 of the projections 53 explained above produce a force transmission.

In the radial direction, the distance between the inner contour 57 and the circular sections 52 is formed small. It has been shown that a multi-disc brake of this type is particularly low-noise. However, this design requires that the outer diameter of the first brake discs 50 is large, which may be achieved without difficulty with the present disclosure.

FIG. 4 shows a front view of a second brake disc 60. Preferably, all of the second brake discs 60 are formed identically to one another, such that they each have the shape shown in FIG. 4. They are each executed as a flat plate having a constant thickness. Preferably, the second brake discs 60 consist of steel, such that they are ferromagnetic. It should be noted here that the preferred sensor (no. 13 in FIG. 1) is optimized for ferromagnetic counting apertures 62.

At the outer contour 61, the second brake disc 60 is provided with a plurality of teeth 63 that are formed identically to one another, wherein they are arranged uniformly distributed over the circumference of the second brake disc 60. The teeth 63 have a rectangular shape in the present case. The inner corners resulting at the tooth gaps 66 and the outer corners on the teeth 63 are executed rounded in each case to facilitate manufacture of the second brake disc 60. The aforementioned teeth 63 form the counting apertures 62, which are scanned by the sensor (no. 13 in FIG. 1).

The outer diameter 64 of the counting apertures 62 is executed somewhat smaller than the outer diameter (no. 55 in FIG. 3) of the circular sections of the first brake discs, such that the teeth 63 are arranged recessed between the first brake discs 50 away from the recesses (no. 54 in FIG. 3). The radial depth of the recesses (no. 54 in FIG. 3) is executed sufficiently large that the teeth 63 project radially outward beyond the recesses (no. 54 in FIG. 3) in the first brake discs, such that they can be readily detected by the sensor (no. 13 in FIG. 1).

The second brake disc 60 is provided with a plurality of, in the present case eight, circular openings 65, which are adjusted with little play to the bolts (no. 35 in FIG. 2) explained above. The circular openings 65 are arranged uniformly distributed around the axis of rotation 11, like the corresponding bolts.

The inner contour 67 of the second brake disc 60 is formed wave-shaped, wherein the distance to the axis of rotation 11 is smallest in each case in the region of the circular openings 65. This inner shape serves for material saving.

### Reference Signs

10 hydrostatic rotary machine
11 axis of rotation
12 working chamber
13 sensor
14 fastening screw
20 outer element
21 stator
22 cam track
23 fluid distributor
24 cam ring
25 main body
30 inner element
31 rotor
32 cylinder
33 piston
34 drive pin
35 bolt
36 roller
40 brake
41 brake piston
42 spring
43 brake chamber
44 pressure ring
45 limiting ring
50 first brake disc
51 outer contour of the first brake disc
52 circular section
53 projection
54 recess
55 outer diameter of the first brake disc or the circular sections
56 relief cut
57 inner contour of the first brake disc
58 side surface of a projection
60 second brake disc
61 outer contour of the second brake disc
62 counting aperture
63 tooth
64 outer diameter of the counting aperture
65 circular opening
66 tooth gap
67 inner contour of the second brake disc
70 rolling body
71 first rotary bearing
72 second rotary bearing

1. A hydrostatic rotary machine comprising:
an inner element;
an outer element, the inner and outer elements being coaxial relative to an axis of rotation and rotatable relative to one another, wherein one of the inner and outer elements is a rotor and the other of the inner and outer elements is a stator,
pistons, which are movable in cylinders, configured to cooperate with a cam track such that a rotational movement of the rotor is accompanied by a stroke movement of the pistons,
a brake configured to counteract the rotational movement of the rotor relative to the stator, the brake comprising a plurality of first brake discs and a plurality of second brake discs, which are arranged alternately along the axis of rotation,
wherein the plurality of first brake discs are connected rotationally fixed relative to the axis of rotation with the outer element,
wherein the plurality of second brake discs are connected rotationally fixed relative to the axis of rotation with the inner element,
wherein a plurality of counting apertures are arranged on the inner element distributed around the axis of rotation, the counting apertures being formed by at least one second brake disc of the plurality of second brake discs, and
wherein a sensor is received in the outer element opposite the counting apertures such that rotation of the rotor results in a signal change at the sensor.

2. The hydrostatic rotary machine according to claim 1, wherein the counting apertures are formed in one piece by the at least one second brake disc.

3. The hydrostatic rotary machine according to claim 1, wherein the counting apertures are arranged on an outer peripheral surface of the at least one second brake disc.

4. The hydrostatic rotary machine according to claim 1, wherein:
the at least one second brake disc includes at least two second brake discs having counting apertures of the plurality of counting apertures, and
the counting apertures of different ones of the at least two second brake discs, when viewed in a direction of the axis of rotation, are arranged in alignment.

5. The hydrostatic rotary machine according to claim 1, wherein at least some of the plurality of counting apertures, which lie in a region of the sensor, project radially outward relative to the axis of rotation beyond at least a portion of the first brake discs.

6. The hydrostatic rotary machine according to claim 5, wherein at least a portion of the first brake discs have a recess in the region of the sensor configured such that the at least some of the plurality of counting apertures which lie in a region of the recess project radially outward relative to the axis of rotation beyond at least the portion of the first brake discs.

7. The hydrostatic rotary machine according to claim 6, wherein an outer diameter of the plurality of counting apertures is smaller than an outer diameter of the first brake discs, such that the plurality of counting apertures are arranged recessed between the first brake discs away from the recess.

8. The hydrostatic rotary machine according to claim 6, wherein the plurality of first brake discs are each formed as a flat plate having a constant thickness, and the recess is formed by an outer contour of a respective first brake disc.

9. The hydrostatic rotary machine according to claim 7, wherein:
the plurality of first brake discs are each formed as a flat plate having a constant thickness, and the recess is formed by an outer contour of a respective first brake disc, and
the outer contour of the first brake disc, away from the recess, has a plurality of circular sections relative to the axis of rotation, and
in a circumferential direction, projections that project radially outward relative to the axis of rotation are arranged between the circular sections, the projections engaging in a form-fitting manner in the outer element.

10. The hydrostatic rotary machine according to claim 1, wherein:
the rotor is mounted rotatably relative to the axis of rotation on the stator by a first rotary bearing and a second rotary bearing,
the pistons are arranged in a direction of the axis of rotation between the first and second rotary bearings,
the first and the second rotary bearing are each formed as rolling bearings, and
corresponding rolling bodies of the rolling bearings run on a diameter that is between 90% and 110% of an average diameter of the cam track.

11. The hydrostatic rotary machine according to claim 1, wherein:
the rotor is mounted rotatably relative to the axis of rotation on the stator by a first roller bearing and a second rotary bearing,
the pistons are arranged in a direction of the axis of rotation between the first and second rotary bearings,
the cam track is arranged on a separate cam ring, and
the cam ring and the first and second rotary bearings are each formed such that the cam ring and the first and second rotary bearings overlap in pairs with respect to their diameter and when viewed in the direction of the axis of rotation.

12. The hydrostatic rotary machine according to claim 1, wherein:
each of the plurality of second brake discs is formed as a flat plate having a constant thickness, and
the counting apertures are formed by an outer contour of a respective one of the plurality of second brake discs.

13. The hydrostatic rotary machine according to claim 1, wherein the plurality of counting apertures are each formed as teeth that are identical to one another and are arranged uniformly distributed over a circumference of the second brake disc.

14. The hydrostatic rotary machine according to claim 1, wherein a central axis of the sensor is oriented radially relative to the axis of rotation, wherein the sensor is arranged radially outside the first and the second brake discs.
